(19) United States
(12) Patent Application Publication
(10) Pub. No.: US 2025/0004997 A1
(43) Pub. Date: Jan. 2, 2025

(54) DATABASE MANAGEMENT DEVICE AND CONTROL METHOD

(71) Applicant: Nippon Telegraph and Telephone Corporation, Tokyo (JP)

(72) Inventors: Sei KOU, Musashino-shi, Tokyo (JP); Takashi YAMADA, Musashino-shi, Tokyo (JP)

(21) Appl. No.: 18/710,862

(22) PCT Filed: Dec. 6, 2021
(86) PCT No.: PCT/JP2021/044745

§ 371 Date: May 16, 2024

(51) Int. Cl. G06F 16/21

(52) U.S. Cl. CPC G06F 16/21

(57) ABSTRACT

An aspect of the present invention is a database management device including: a generation unit for generating a database; a monitoring unit for monitoring a physical quantity having a positive correlation with a usage of the database generated by the generation unit; and a management unit instructing the generation unit to generate a new database as the database to be used subsequent to the database currently in use when the physical quantity monitored by the monitoring unit exceeds a threshold value, and the generation unit reserves a region for storing the new database within a storage device and generates the new database in the reserved region when instructed to generate the new database by the management unit.

### TECHNICAL FIELD

The present invention relates to a technique of a database management device and a control method.

### BACKGROUND ART

Various data are acquired from each device configuring a computer system in an operation management of the computer system in order to detect a failure or an abnormality of each device or predict an occurrence of the abnormality (see FIG. 6). The acquired data is recorded in a database, and analyses are performed on the data. The data acquired from each device includes a central processing unit (CPU) usage rate and various logs defined in a system logging protocol (Syslog).

Frequencies at which these time-series data are recorded in the database and a storage period of the database are often different depending on a type of the database. Therefore, an administrator of the databases is required to perform the operation management for each of the databases. Techniques related to an automatic generation of the database are disclosed regarding the operation management of the database (see Patent Literatures 1 and 2).

### CITATION LIST

### Patent Literature

Patent Literature 1: JP 2003-228570 A
Patent Literature 2: JP H10-111819 A

### SUMMARY OF INVENTION

### Technical Problem

As illustrated in FIG. 7, management work of the database performed by the administrator includes
a usage management of the database and a storage period limit management of the database. For example, when a remaining capacity of the database decreases, the administrator prepares a new database. In this work, in a case where the new database is prepared with a margin in a remaining capacity, a free space of a storage device storing the database may be wastefully consumed. On the other hand, in a case where there is no margin in the remaining capacity, since a database capacity is insufficient, sufficient performance may not be obtained, such as not being able to record data. Under such circumstances, since it is necessary for the administrator to perform management work after intermittently monitoring, there is a problem that the workload of the administrator is heavy.

In view of the above circumstances, an object of the present invention is to provide a technique for reducing the workload of the administrator of the database. In addition, another object is to effectively use a storage area for recording data without waste.

### Solution to Problem

An aspect of the present invention is a database management device including: a generation unit for generating a database; a monitoring unit for monitoring a physical quantity having a positive correlation with a usage of the database generated by the generation unit; and a management unit instructing the generation unit to generate a new database as the database to be used subsequent to the database currently in use when the physical quantity monitored by the monitoring unit exceeds a threshold value, and the generation unit reserves a region for storing the new database within a storage device and generates the new database in the reserved region when instructed to generate the new database by the management unit.

An aspect of the present invention is a method for controlling a database management device, the method including: a step of acquiring a physical quantity having a positive correlation with a usage of a database; and a step of reserving a region for storing a new database within a storage device and generating the new database in the reserved region as the database to be used subsequent to the database currently in use when the physical quantity exceeds a threshold value.

### Advantageous Effects of Invention

According to the present invention, the workload of the administrator of the database can be reduced. In addition, the storage area for recording data can be effectively used without waste.

### BRIEF DESCRIPTION OF DRAWINGS

FIG. 1 is a block diagram illustrating a configuration of a database management system.

FIG. 2 is a diagram illustrating an example of setting data.

FIG. 3 is a diagram illustrating an example of setting data.

FIG. 4 is a flowchart illustrating a flow of processing of a database management device.

FIG. 5 is a flowchart illustrating a flow of processing of the database management device.

FIG. 6 is a diagram illustrating a state in which data is acquired from a management target device.

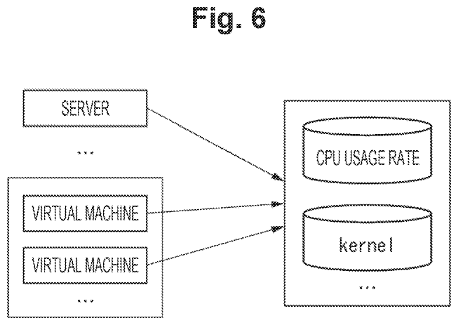

FIG. 7 is a diagram illustrating an example of management work of an administrator.

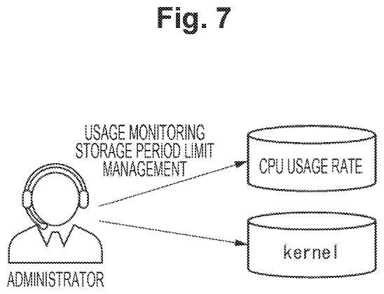

### DESCRIPTION OF EMBODIMENTS

An embodiment of the present invention will be described in detail with reference to the drawings.

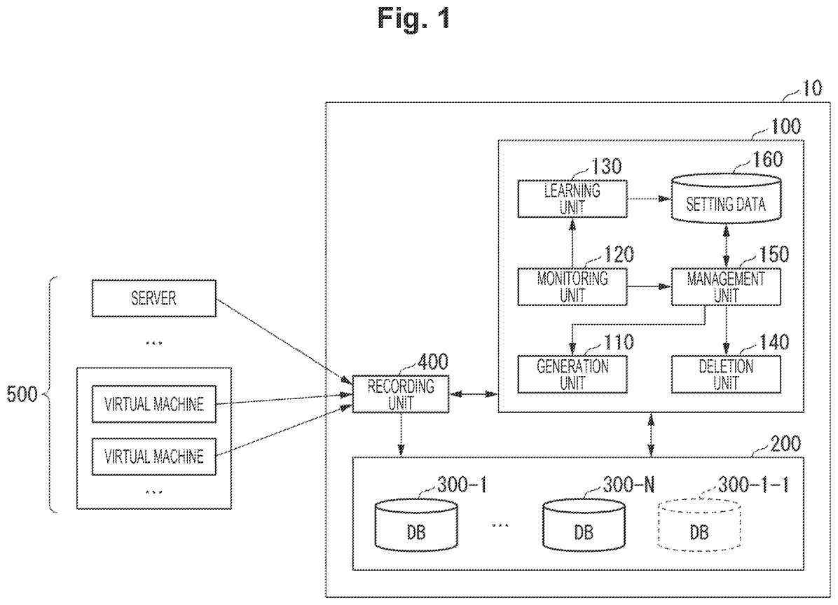

FIG. 1 is a block diagram illustrating a configuration of a database management system 10 including a database management device 100 according to an embodiment. The database management system 10 is a system that acquires data from a management target device 500 and records the data in the database. The management target device 500 is a server, a virtual machine built in the server, or the like.

The database management system 10 includes the database management device 100, a storage device 200, and a recording unit 400. The database management device 100 manages the database recorded in the storage device 200. In addition, when the database is full, the database management device 100 instructs the recording unit 400 to switch the recording destination to a new database. Note that the term “full” may indicate that all of the database has been used, or may be a value that is not completely full (for example, a value close to full, such as 90%), such as 97% of the capacity of the database.

The recording unit 400 records the data acquired from the management target device 500 in the database. The storage device 200 includes a non-volatile storage device, such as a hard disk drive (HDD) or a solid state drive (SSD). The databases for various types of data are generated in the storage device 200. In the present embodiment, databases 300-1 and 300-N are stored in the storage device 200 in order to record N types of data. In addition, the database newly generated for recording the same type of data as a certain database is also stored. FIG. 1 illustrates, as an example, a database 300-1-1 newly generated for recording the same type of data as the database 300-1. In the following description, when the databases 300-1, 300-N, 300-1-1, and the like are not distinguished from one another, they are expressed as a database 300.

The database management device 100 includes a generation unit 110, a monitoring unit 120, a learning unit 130, a deletion unit 140, a management unit 150, and setting data 160. The generation unit 110 generates the database in the storage device 200. The monitoring unit 120 monitors a physical quantity having a positive correlation with a usage of the database generated by the generation unit 110. The monitoring unit 120 acquires the physical quantity with reference to the storage device 200 each time a predetermined monitoring time (for example, on the hour) arrives. When the physical quantity exceeds the threshold value, the monitoring unit 120 notifies the management unit 150 that the physical quantity exceeds the threshold value. In addition, also in a case where the database is full, the monitoring unit 120 notifies the management unit 150 that the database is full.

In the present embodiment, a usage rate calculated by dividing a data size in which data is actually recorded in one database 300 by a size of the database is used as the physical quantity. For example, in a case where the size of the database 300-1 is 100 megabytes and the data size in which data is actually recorded is 70 megabytes, the usage rate of the database 300-1 is 70%.

When the usage rate monitored by the monitoring unit 120 exceeds the threshold value, the management unit 150 instructs the generation unit 110 to generate the new database as the database to be used next to the currently used database. When instructed to generate the new database from the management unit 150, the generation unit 110 secures an area for storing the new database in the storage device 200, and generates the new database in the secured area. At this time, the management unit 150 refers to the setting data 160, acquires the format and the size of the database to be generated, and specifies the type and the size of the database to be generated to the generation unit 110. Moreover, in a case where the database is full, the management unit 150 instructs the recording unit 400 to switch a recording destination to the new database already prepared.

The setting data 160 is stored in the nonvolatile storage device. The setting data is set by an administrator of the database management device 100 when the new database in which the setting data is not set is created, and is then updated by the database management device 100 as described later. After setting the setting data, the administrator can input a generation instruction of the new database to the database management device 100.

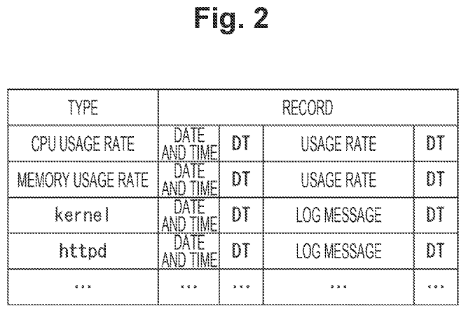

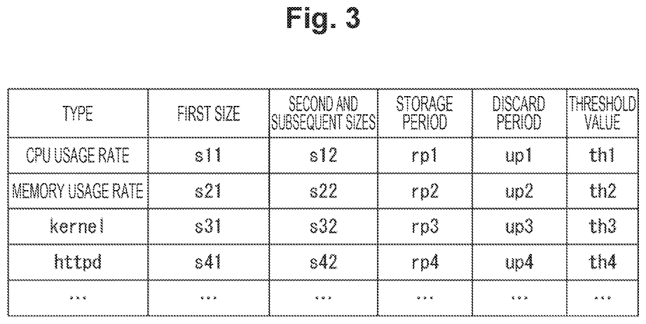

FIGS. 2 and 3 are diagrams illustrating an example of the setting data 160. FIG. 2 is a diagram illustrating a format data among the setting data. The format data indicates the format of each type of database. The format indicates the type and a data structure of one record corresponding to the type.

In FIG. 2, a central processing unit (CPU) usage rate, a memory usage rate, kernel, and httpd are used as examples of types. The CPU usage rate indicates the CPU usage rate in the server or the virtual machine. The memory usage rate indicates the usage rate of a random access memory (RAN) in the server or the virtual machine. Kernel and httpd are data types defined in the system logging protocol (Syslog). The types of these databases are examples.

The record includes a combination of a data name (“date and time”, “usage rate”, and the like are illustrated in FIG. 2.) and a data type (“DT” in FIG. 2). The data type indicates the type of the data, such as an integer type or a character type, and a size of the data. For example, when the data type is “INT”, it indicates an integer type and the size of 4 bytes. When the data type is “CHAR (10)”, it indicates a character type and the size of 10 bytes.

The date and time in the record of the CPU usage rate illustrated in FIG. 2 indicates the date and time when the CPU usage rate is detected. A numerical value of 0 to 100(%) is recorded in the usage rate in the record of the CPU usage rate. The date and time in the record of the memory usage rate indicates the date and time when the memory usage rate is detected. A numerical value of 0 to 100(%) is recorded in the usage rate in the record of the CPU usage rate. The date and time in the record of kernel indicates the date and time when the log message is acquired. A character string indicating a log is recorded in the log message in the record of kernel. The date and time in the record of httpd indicates the date and time when the log message is acquired. The character string indicating the log is recorded in the log message in the record of httpd.

FIG. 3 is a diagram illustrating management data among the setting data. The management data includes the type, a first size, a second and subsequent sizes, a storage period, a discard period, and the threshold value. The type indicates the type of the database. The first size indicates the size of the database to be generated when the generation unit 110 generates one type of database in a state where the one type of database is not generated. That is, the size of a newly generated database is indicated. Symbols s11, s21, s31, and s41 described in the first size indicate the sizes in a case of generating the databases of the CPU usage rate, the memory usage rate, kernel, and httpd, respectively.

The second and subsequent sizes indicate sizes of databases to be generated in a case where the generation unit 110 generates the one type of database in the state where the one type of database is generated. That is, the size of the database is indicated in a case where a database of the same type as the type of the database already existing in the storage device 200 is newly generated. The second and subsequent sizes are the sizes corresponding to use modes of one type of database generated in the past. In the present embodiment, a recording frequency in the database within a predetermined period is selected as an example of the use mode. The sizes s12, s22, s32, and s42 described in the second and subsequent sizes indicate the sizes in a case where the databases of the CPU usage rate, the memory usage rate, kernel, and httpd are generated, respectively.

The first size and the second and subsequent sizes may be expressed in units indicating sizes (byte, megabyte, etc.), or may be expressed in the number of records.

The storage period among the management data indicates the storage period of the database. The date on which the storage period expires is expressed as a storage period limit. For example, in a case where the storage period is 30 days and the database is generated on January 1st, the storage period of the database is from January 1st to January 30th which is the storage period limit. Symbols rp1, rp2, rp3, and rp4 described in the storage period indicate the storage period of the databases of the CPU usage rate, the memory usage rate, kernel, and httpd, respectively.

The discard period is the period from immediately after the storage period expires until the deletion unit 140 deletes the database. The date on which the discard period expires is expressed as a discard period limit. When the discard period limit arrives, the management unit 150 instructs the deletion unit 140 to delete the database whose discard period limit has arrived. For example, in a case where the discard period is set to zero day, the database is deleted as the storage period expires. Regarding the operation of the storage period and the discard period, there is an operation in which the deletion of the database is prohibited during the storage period, and the discard period may be determined depending on the amount of free space of the storage device 200. Symbols up1, up2, up3, and up4 described in the discard periods indicate the discard periods of the databases of the CPU usage rate, the memory usage rate, kernel, and httpd, respectively.

The threshold value is a value to be compared with the usage rate by the monitoring unit 120, and the value for determining whether or not to instruct the generation unit 110 to generate the new database as the database to be used next to the currently used database. When the usage rate exceeds the threshold value, the management unit 150 instructs the generation unit 110 to generate the new database as the database to be used next to the currently used database. Symbols th1, th2, th3, and th4 described in the threshold value indicate the threshold values for determining whether to newly generate the databases of the CPU usage rate, the memory usage rate, kernel, and httpd, respectively.

The threshold value may be constant, but may be dynamically changed according to the data recording frequency. For example, since the free space rapidly decreases in a case where the recording frequency is high, the threshold value may be changed to be low. Specifically, the management unit 150 may calculate a data size consumed in one day on the basis of the recording frequency, and may set the threshold value as a new threshold value at which the new database can be generated two days before the database becomes full when consumed at a calculated data size. As a result, not only in a case where the recording frequency is high but also in a case where the recording frequency is low, the data is recorded in the new database after two days. This indicates that the database is prepared two days before regardless of the data recording frequency. Therefore, since the next database can be prevented from being generated earlier than necessary, the storage area for recording data can be effectively used without waste, and the database can be suitably managed.

Among the setting data described above, the format data, the first size, the second and subsequent sizes, the storage period, and the discard period are referred to by the management unit 150. The threshold value is referred to by the monitoring unit 120. In the present embodiment, time-series data such as the CPU usage rate and kernel of Syslog is recorded as an example of data stored in the database, but the present invention is not limited to the time-series data. In the present embodiment, the data to be stored in the database may not be the time-series data, but may be data that is recorded so as to be accumulated in the database (so that the free space monotonically decreases).

The description returns to FIG. 1. The learning unit 130 sets the data size of the newly generated database as the second and subsequent sizes in the setting data 160 for each type of database. Specifically, the learning unit 130 acquires the recording frequency for one type of database within the predetermined period from the recording unit 400. In addition, the learning unit 130 acquires the recording size within the period in which the data is actually recorded within the predetermined period from the monitoring unit 120. The learning unit 130 trains a regression model using the acquired recording frequency and the recording size within the period. The learning unit 130 outputs the data size (second and subsequent sizes) corresponding to one type of database to be newly generated using this regression model by receiving the instruction from the management unit 150. Examples of the predetermined period include the storage period indicated in the management data, but may be set by the administrator. In a case where the predetermined period is set as the storage period, the second and subsequent sizes increase as the recording frequency increases.

As described above, since the size of the database is determined according to the use mode of the database, the database management device 100 can effectively use the storage area for recording data without waste.

As another example of the use mode, a recording time of the data recorded in the database may be used. For example, in a case where there is the correlation such as more data to be recorded in a database with a larger recording time at night, the learning unit 130 trains the regression model using the acquired recording time and the recording size within the period. The learning unit 130 outputs the data size corresponding to one type of database to be newly generated by using the regression model. The use mode may be any mode as long as it has some correlation with the size of the database.

The deletion unit 140 deletes the database whose discard period limit has arrived in response to the instruction from the management unit 150. As a result, since the free capacity of the storage device 200 increases, the database management device 100 can effectively use the storage area for recording data without waste. When the discard period limit has arrived, the storage period has expired. Therefore, it can be said that the deletion unit 140 deletes the database whose storage period has expired.

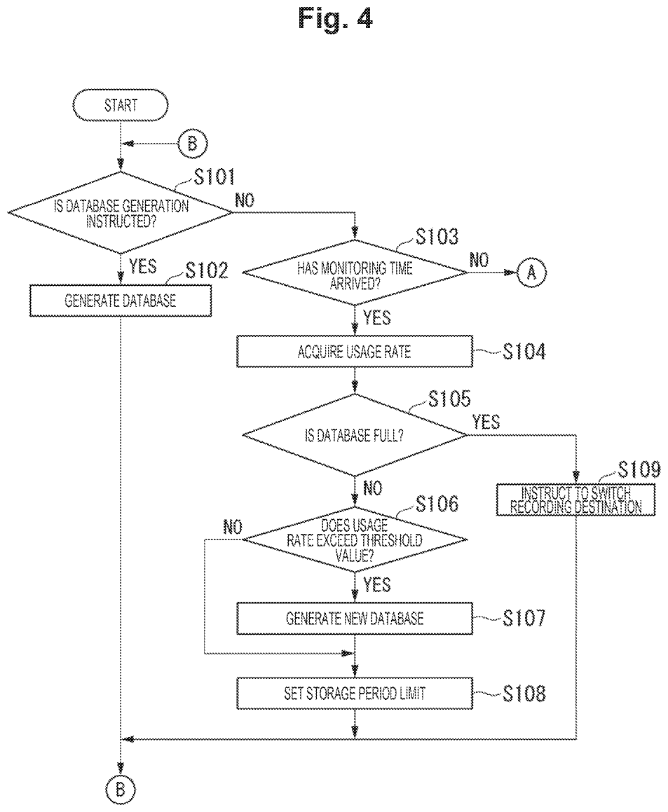

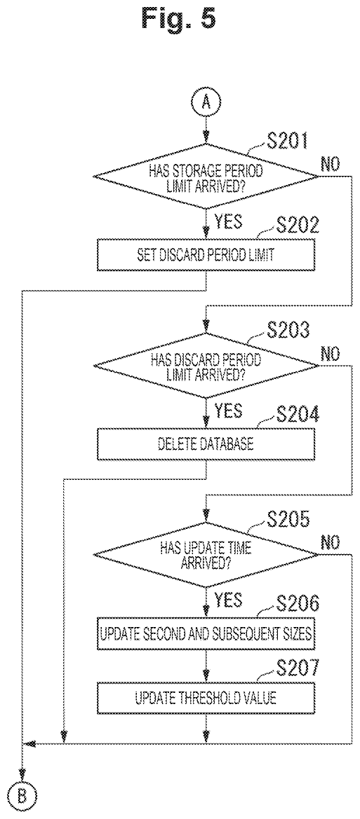

Next, a flow of processing in the database management device 100 will be described. FIGS. 4 and 5 are flowcharts illustrating a flow of processing in the database management device 100. The management unit 150 determines whether or not the instruction to generate the new database is input by the administrator (step S101). At this time, the administrator specifies the type of the database to be generated. When the administrator inputs an instruction to generate the new database (step S101: YES), the management unit 150 instructs the generation unit to generate the database of a specified type. The generation unit 110 secures the area for storing the new database in the storage device 200 according to the instruction, generates the new database in the secured area (step S102), and returns to step S101.

When the instruction to generate the new database is not input by the administrator (step S101: NO), the monitoring unit 120 determines whether the monitoring time of the database has arrived (step S103). When the monitoring time of the database arrives (step S103: YES), the monitoring unit 120 refers to the storage device 200 to acquire the usage rate (step S104). At this time, the monitoring unit 120 acquires the usage rates of all types of databases.

The monitoring unit 120 determines whether the database is full (step S105). The determination here is also made for all types of databases. In a case where it is determined that the database is not full (step S105: NO), the monitoring unit 120 refers to the threshold value of the setting data and determines whether or not the usage rate exceeds the threshold value (step S106). The determination here is also made on the usage rates of all types of databases. When the usage rate exceeds the threshold value (step S106: YES), the monitoring unit 120 notifies the management unit 150 that the usage rate exceeds the threshold value. At this time, the type of the database exceeding the threshold value is also notified. The management unit 150 instructs the generation unit 110 to generate the new database as the database to be used next to the currently used database. When generation of the new database is instructed from the management unit 150, the generation unit 110 secures the area for storing the new database in the storage device 200, and generates the new database in the secured area (step S107). The management unit 150 refers to the storage period limit of the setting data to set the storage period limit of the generated database (step S108), and returns to step S101.

When it is determined in step S105 described above that the database is full (step S105: YES), the monitoring unit 120 notifies the management unit 150 that the database is full. The management unit 150 instructs the recording unit 400 to switch the recording destination to the new database that has already been prepared (step S109), and returns to step S103.

In step S103 described above, in a case where the monitoring time of the database has not arrived (step S103: NO), the process proceeds to step S201 in FIG. 5. The management unit 150 determines whether the storage period limit has arrived (step S201). The determination here is made for all the databases for which the storage period limits are set. In a case where the storage period limit has arrived (step S201: YES), the management unit 150 refers to the setting data to set the discard period limit for all the databases for which the storage period limit has arrived (step S202), and returns to step S101.

In a case where the storage period limit has not arrived (step S201: NO), the management unit 150 determines whether or not the discard period limit has arrived (step S203). The determination here is made for all the databases for which the discard period limit is set. In a case where the discard period limit has arrived (step S203: YES), the management unit 150 instructs the deletion unit 140 to delete the database whose discard period limit has arrived. In response to the instruction from the management unit 150, the deletion unit 140 deletes the database for which the discard period limit has arrived (step S204), and returns to step S101.

In a case where the discard period limit has not arrived (step S203: NO), the management unit 150 determines whether the update time has arrived (step S205). The update time is the time when the second and subsequent sizes and the threshold value are updated. When the update time has arrived (step S205: YES), the management unit 150 instructs the learning unit 130 to output the second and subsequent sizes. Here, the output of the second and subsequent sizes of all types of databases is instructed. The learning unit 130 outputs the second and subsequent sizes of all types of databases using the regression model, thereby updating the second and subsequent sizes in the setting data (step S206).

Next, the management unit 150 calculates the data size consumed in one day on the basis of the recording frequency, updates the threshold value in the setting data (step S207), and returns to step S101. In a case where the update time has not arrived (step S205: NO), the process returns to step S101.

As described above, in the present embodiment, when the physical quantity positively correlated with the usage of the database exceeds the threshold value, the database to be used next to the currently used database is automatically generated, thus the workload of the administrator of the database can be reduced.

Furthermore, when the physical quantity positively correlated with the usage of the database exceeds the threshold value, the generation unit 110 secures the area for storing the new database in the storage device 200, and generates the new database in the secured area. Conventionally, in a case where the database is generated, a larger area is secured with a margin, but in the present embodiment, the area is secured as necessary. As a result, since the area is not unnecessarily secured, the storage area for recording data can be effectively used without waste, and the database whose storage period limit has arrived is deleted. Therefore, the storage area for recording data can be effectively used without waste, and the database can be suitably managed.

In addition, the second and subsequent sizes are specified according to the use mode of one type of database generated in the past. For example, since the second and subsequent sizes are output using the regression model trained by the learning unit 130, the storage area for recording data can be effectively used without waste. Note that, in a case where the database generation timing is set to be periodic, the regression model is trained such that the predetermined period is specified as a desired period set to be periodic. As a result, the generation frequency of the database can also be adjusted.

Furthermore, by changing the threshold value according to the data recording frequency with respect to the database, even when the data recording frequency rapidly increases, the administrator can automatically changes the threshold value to generate the database without performing special work. As a result, the workload of the administrator of the database can be reduced. On the other hand, since it is possible to prevent the next database from being generated earlier than necessary by increasing the threshold value when the data recording frequency becomes high, it is easy to effectively use the storage area for recording data without waste and to suitably manage the database.

In the present embodiment, the usage rate is used as the physical quantity positively correlated with the usage of the database, but the physical quantity is not limited to the usage rate. For example, a unit (gigabyte, terabyte, etc.) indicating the size may be used as the physical quantity.

The database management device 100 may be configured using a processor such as a central processing unit (CPU) and a memory. In this case, the generation unit 110, the monitoring unit 120, the learning unit 130, the deletion unit 140, and the management unit 150 function as the generation unit 110, the monitoring unit 120, the learning unit 130, the deletion unit 140, and the management unit 150 by the processor executing a program. All or some of the functions of the generation unit 110, the monitoring unit 120, the learning unit 130, the deletion unit 140, and the management unit 150 may be realized by using a hardware such as an application specific integrated circuit (ASIC), a programmable logic device (PLD), or a field programmable gate array (FPGA). The program may be recorded in a computer-readable recording medium. The computer-readable recording medium is, for example, a portable medium such as a flexible disk, a magneto-optical disc, a ROM, a CD-ROM, or a semiconductor storage device (for example, a solid state drive (SSD)), or a storage device such as a hard disk or a semiconductor storage device built into a computer system. The above program may be transmitted via a telecommunication line.

Although the embodiments of the present invention have been described in detail with reference to the drawings, the specific configuration is not limited to the embodiments, and includes design and the like without departing from the spirit of the present invention.

### INDUSTRIAL APPLICABILITY

The present invention is applicable to a system that manages a database.

### REFERENCE SIGNS LIST

10 database management system
100 database management device
110 generation unit
120 monitoring unit
130 learning unit
140 deletion unit
150 management unit
200 storage device
300, 300-1, 300-N, 300-1-1 database
400 recording unit
500 management target device

1. A database management device comprising one or more processors configured to perform operations comprising:
generating a database;
monitoring a physical quantity having a positive correlation with a usage of the generated database;
instructing to generate a new database as the database to be used subsequent to the database currently in use when the physical quantity exceeds a threshold value; and
reserving a region for storing the new database within a storage device and generating the new database in the reserved region when instructed to generate the new database.

2. The database management device according to claim 1, wherein the operations comprise:
specifying a type of the database to be generated and a size of the database when instructing to generate the database.

3. The database management device according to claim 2, wherein the operations comprise:
specifying the size of the database to be generated to a constant size when instructing to generate one type of database in a state where the one type of database is not generated, and
specifying the size of the database to be generated to a size according to a use mode of the one type of database generated in the past when instructing to generate one type of database in the state where the one type of database is generated.

4. The database management device according to claim 3, wherein
the use mode is a recording frequency of data for one type of database,
the operations further comprise: outputting a data size of the one type of database to be newly generated by using a regression model created by learning a relation between the recording frequency and the data size of the one type of database, and specifying the data size of the one type of database to be newly generated to the size corresponding to the output data size.

5. The database management device according to claim 1, wherein the operations comprise: changing the threshold value according to a recording frequency of data in the database.

6. The database management device according to claim 1, wherein a storage period is specified for the database, and the operations comprise: deleting the database whose storage period has expired.

7. A method for controlling a database management device, the method comprising:
acquiring a physical quantity having a positive correlation with a usage of a database; and
reserving a region for storing a new database within a storage device and generating the new database in the reserved region as the database to be used subsequent to the database currently in use when the physical quantity exceeds a threshold value.

8. The method for controlling a database management device according to claim 7, wherein the size of the database to be generated is specified to a constant size in generating the database when one type of database is generated in a state where the one type of database is not generated, and the size of the database to be generated is specified to a size according to a use mode of the one type of database generated in the past when one type of database is generated in the state where the one type of database is generated.
